(19) United States
(12) Patent Application Publication
(10) Pub. No.: US 2019/0063541 A1
(43) Pub. Date: Feb. 28, 2019

(54) OSCILLATION DAMPER, A DAMPER INNER PIPE, A DAMPER OUTER PIPE AND A METHOD FOR PRODUCING A DOUBLE PIPE OF AN OSCILLATION DAMPER

(71) Applicants: ThyssenKrupp Bilstein GmbH, Ennepetal (DE); Thyssenkrupp AG, Essen (DE)

(72) Inventors: Martin Flick, Gummersbach (DE); Daniel Pitsch, Koln (DE)

(73) Assignees: ThyssenKrupp Bilstein GmbH, Ennepetal (DE); Thyssenkrupp AG, Essen (DE)

(21) Appl. No.: 16/106,982

(22) Filed: Aug. 21, 2018

(30) Foreign Application Priority Data
Aug. 25, 2017 (DE) 10 2017 214 946.9

(51) Int. Cl. F16F 9/22

(52) U.S. Cl. CPC F16F 9/22; F16F 2226/04

(57) ABSTRACT

An oscillation damper includes a damper inner pipe with a damper inner pipe wall thickness and a damper inner pipe outer wall. A piston rod and piston are reciprocally movable in the damper inner pipe. The damper inner pipe is divided into a piston-rod-side operating space and an operating space remote from the piston rod. A damper outer pipe has a damper outer pipe wall thickness and a damper outer pipe inner wall. The damper outer pipe is arranged around the damper inner pipe and the damper outer pipe is fluidly connected to the damper inner pipe at the side of the operating space remote from the piston rod. The oscillation damper includes support elements arranged between the damper outer pipe inner wall and the damper inner pipe outer wall wherein the damper inner pipe is at least partially supported with respect to the damper outer pipe.

### CROSS-REFERENCE TO RELATED APPLICATION

This application is a non-provisional application claiming priority to German Patent Application No. DE 10 2017 214 946.9, which was filed Aug. 25, 2017, the entire contents of which are hereby incorporated by reference herein.

### FIELD

The present disclosure generally relates to an oscillation damper, a damper inner pipe, a damper outer pipe and a method for producing a double pipe of an oscillation damper.

### BACKGROUND

Oscillation dampers and methods for producing a double pipe of an oscillation damper are known in the prior art in a large number of embodiments.

DE 10 230499 C1 discloses an oscillation damper having a damper inner pipe which is arranged in a damper outer pipe.

The problem with the embodiments known in the prior art is that they have large installation dimensions and consequently take up a large spatial requirement which makes installation in a vehicle more difficult. A reduction of installation dimensions is not readily possible as a result of strength requirements. In addition, a reduction of the weight with embodiments known from the prior art is not readily possible as a result of strength requirements.

Thus, a need exists for an improved oscillation damper, in which the previously mentioned disadvantages are avoided. There is provided herein an improved oscillation damper which with the same or smaller damper pipe wall thicknesses has the same or improved strength properties of the oscillation damper, in particular of damper pipes. In addition, an oscillation damper is provided herein which has a reduced weight with the same or improved strength properties of the oscillation damper, in particular of damper pipes. Furthermore, an oscillation damper with the same or improved strength properties and a reduced installation spatial requirement is provided herein. In addition, a method for producing an improved double pipe of an oscillation damper which can be carried out in a simple manner and without additional method steps is provided herein.

### BRIEF DESCRIPTION OF THE FIGURE

FIG. 1 is a schematic longitudinal sectional view through an oscillation damper according to an embodiment of the disclosure.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting ‘a’ element or ‘an’ element in the appended claims does not restrict those claims to articles, apparatuses, systems, methods, or the like having only one of that element, even where other elements in the same claim or different claims are preceded by ‘at least one’ or similar language. Similarly, it will be understood that the steps of any method claims need not necessarily be performed in the order in which they are recited, unless so required by the context of the claims. In addition, all references to one skilled in the art shall be understood to refer to one having ordinary skill in the art.

The present disclosure relates to an oscillation damper, a damper inner pipe, a damper outer pipe and a method for producing a double pipe of an oscillation damper.

The subject-matter of the disclosure is an oscillation damper including:
a damper inner pipe which is at least partially filled with a damping fluid and which has a damper inner pipe wall thickness and a damper inner pipe outer wall, wherein a piston rod can be moved back and forth in the damper inner pipe, wherein there can also be moved with the piston rod a working piston by means of which the inner space of the damper inner pipe is divided into a piston-rod-side operating space and an operating space remote from the piston rod,
a damper outer pipe having a damper outer pipe wall thickness and a damper outer pipe inner wall, wherein the damper outer pipe is arranged around the damper inner pipe and the damper outer pipe is connected in fluid terms to the damper inner pipe at least at the end of the damper inner pipe at the side of the operating space remote from the piston rod,
wherein the oscillation damper includes a plurality of support elements, wherein the plurality of support elements is arranged in such a manner in a region between the damper outer pipe inner wall and the damper inner pipe outer wall that the damper inner pipe is at least partially supported with respect to the damper outer pipe.

Another aspect of subject-matter of the disclosure is a damper inner pipe for an oscillation damper, wherein the damper inner pipe includes a plurality of support elements.

Another aspect of subject-matter of the disclosure is a damper outer pipe for an oscillation damper, wherein the damper outer pipe includes a plurality of support elements.

Another aspect of subject-matter of the disclosure is a method for producing a double pipe of an oscillation damper including the steps of:
a) providing a damper inner pipe having a damper inner pipe wall thickness and a damper inner pipe outer wall for an oscillation damper,
b) providing a damper outer pipe having a damper outer pipe wall thickness and a damper outer pipe inner wall for an oscillation damper, and
c) fitting a damper inner pipe in the damper outer pipe with a spacing being produced,
d) wherein the damper inner pipe provided in step a) and/or the damper outer pipe provided in step b) includes a plurality of support elements and the spacing between the damper outer pipe inner wall and the damper inner pipe outer wall is carried out by means of the plurality of support elements.

The present disclosure may be implemented in an oscillation damper of a damper inner pipe, a damper outer pipe and a method for producing a double pipe of an oscillation damper.

The oscillation damper according to the disclosure includes, compared with conventional oscillation dampers having a damper inner pipe which is arranged in a damper outer pipe, the advantage that the oscillation damper according to the disclosure with the same or improved strength properties has a reduced weight, in particular reduced damper pipe wall thicknesses, or with the same damper pipe wall thicknesses has improved strength properties of the oscillation damper according to the disclosure. In particular the oscillation damper according to the disclosure has a better ratio of damper outer pipe outer diameter to damper inner pipe inner diameter. For example, with the same or improved strength properties and with the same or smaller damper outer pipe outer diameter, a larger damper inner pipe inner diameter can be provided. Furthermore, an oscillation damper according to the disclosure has with the same or improved strength properties a smaller installation spatial requirement in a vehicle.

The method according to the disclosure for producing a double pipe of an oscillation damper has compared with conventional methods the advantage that it is less failure-prone, can be carried out in a simple manner and no additional method step is required.

In the context of the present disclosure, a support element is intended to be understood to be a spacer element, in particular a spacer, which at least on a parallel axis with respect to the longitudinal axes of the damper pipes which are arranged one inside the other is at least partially supported one against the other. For example, in a damper inner pipe which is arranged on a longitudinal parallel axis in a damper outer pipe one of the damper pipes is supported with respect to the other with a plurality of support elements and/or both damper pipes are supported with respect to each other with a plurality of support elements, wherein the spacing, in particular the intermediate space between the damper pipes, is determined at least partially by the plurality of support elements.

According to another embodiment of the disclosure, the damper inner pipe is arranged coaxially inside the damper outer pipe.

According to another embodiment of the disclosure, the plurality of support elements is arranged on the damper outer pipe inner wall of the damper outer pipe and/or on the damper inner pipe outer wall of the damper inner pipe.

In another embodiment of the disclosure, the plurality of support elements is selected from a group of spacer elements, ribs, projections, prongs, tines, beads, spurs, lugs, knobs, protrusions, plates, webs or a combination thereof.

According to another embodiment of the disclosure, the plurality of support elements is arranged in a different direction from the transverse direction of the damper outer pipe and/or the damper inner pipe. In the context of the present disclosure, the transverse direction of the damper outer pipe and/or the damper inner pipe is intended to be understood to be the direction transverse, that is to say, at an angle of 90°, with respect to the longitudinal axis of the damper outer pipe and/or the damper inner pipe.

In another embodiment of the disclosure, the plurality of support elements has in the peripheral direction of the damper outer pipe and/or the damper inner pipe the same spacing with respect to each other.

According to another embodiment of the disclosure, each of the support elements of the plurality of support elements is arranged radially opposite another of the plurality of support elements. In particular the number of the plurality of support elements is an even number of support elements.

In the context of the present disclosure, a spacing is intended to be understood to be the provision of a spacing, in particular an intermediate space between two damper pipes which are arranged at least partially on a parallel axis with respect to the longitudinal axes of the damper pipes which are arranged one inside the other. For example, in a damper inner pipe which is arranged on a longitudinal parallel axis in a damper outer pipe, one of the damper pipes is spaced apart with respect to the other.

According to another embodiment of the disclosure, the oscillation damper is constructed as a double-pipe damper. In particular the damper inner pipe and the damper outer pipe are coupled to each other in fluid terms so that damping fluid can flow between the two damper pipes.

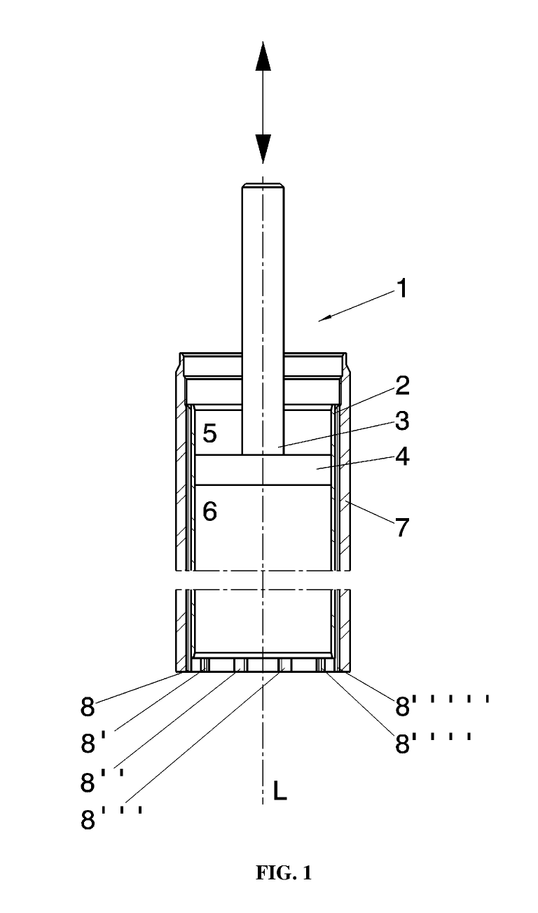

FIG. 1 is a longitudinal section along a longitudinal axis L through an oscillation damper 1 according to an embodiment of the disclosure. The oscillation damper 1 includes a damper inner pipe 2 which is at least partially filled with damping fluid and which has a damper inner pipe wall thickness and a damper inner pipe outer wall, wherein in the damper inner pipe 2 a piston rod 3 which can be moved back and forth is illustrated by means of a double-headed arrow, wherein there can also be moved with the piston rod 3 a working piston 4 by means of which the inner space of the damper inner pipe 2 is divided into a piston-rod-side operating space 5 and an operating space 6 remote from the piston rod. Furthermore, the oscillation damper 1 includes a damper outer pipe 7 having a damper outer pipe wall thickness and a damper outer pipe inner wall, wherein the damper outer pipe 7 is arranged around the damper inner pipe 2 and the damper outer pipe 7 is connected in fluid terms to the damper inner pipe 2 at least at the end of the damper inner pipe 2 at the side of the operating space 6 remote from the piston rod. The oscillation damper 1 includes a plurality of support elements 8, 8′, 8″, 8″′, 8″″, 8″″′, wherein the plurality of support elements 8, 8′, 8″, 8″′, 8″″, 8″″′ are arranged and constituted in such a manner in a region between the damper outer pipe inner wall and the damper inner pipe outer wall that the damper inner pipe 2 is at least partially supported with respect to the damper outer pipe 7. As illustrated, in the damper inner pipe 2 which is arranged on a longitudinal parallel axis in the damper outer pipe 7, one of the damper pipes 2, 7 is spaced apart with respect to the other 2, 7 by means of the plurality of support elements 8, 8′, 8″, 8″′, 8″″, 8″″′.

### INDUSTRIAL APPLICABILITY

The oscillation damper, damper inner pipes, damper outer pipes and method for producing a double pipe of an oscillation damper of the above-described type are used in the production of vehicles, in particular of chassis of motor vehicles.

What is claimed is:

1. An oscillation damper, comprising:
a damper inner pipe which is at least partially filled with a damping fluid, the damper inner pipe including:
a damper inner pipe wall thickness,
a damper inner pipe outer wall,
the damper inner pipe configured to reciprocally receive a piston rod and a working piston by means of which an inner space of the damper inner pipe is divided into a piston-rod-side operating space and an operating space remote from the piston rod,
a damper outer pipe, including:
a damper outer pipe wall thickness, and
a damper outer pipe inner wall,
wherein the damper outer pipe is arranged around the damper inner pipe and is fluidly connected to the damper inner pipe at least at an end of the damper inner pipe at a side of the operating space remote from the piston rod, and
a plurality of support elements arranged between the damper outer pipe inner wall and the damper inner pipe outer wall and configured such that the damper inner pipe is at least partially supported with respect to the damper outer pipe.

2. The oscillation damper of claim 1, wherein the damper inner pipe is arranged coaxially inside the damper outer pipe.

3. The oscillation damper of claim 1, wherein the plurality of support elements is arranged on the damper outer pipe inner wall of the damper outer pipe and/or on the damper inner pipe outer wall of the damper inner pipe.

4. The oscillation damper of claim 1, wherein the plurality of support elements is selected from one or more of spacer elements, ribs, projections, prongs, tines, beads, spurs, lugs, knobs, protrusions, plates, and webs.

5. The oscillation damper of claim 1, wherein the plurality of support elements is arranged in a direction different from a transverse direction of the damper outer pipe and/or the damper inner pipe.

6. The oscillation damper of claim 1, wherein the plurality of support elements has, in a peripheral direction of the damper outer pipe and/or the damper inner pipe, the same spacing with respect to each other.

7. The oscillation damper of claim 1, wherein each support element of the plurality of support elements is arranged in a radially opposite direction with respect to another of the plurality of support elements.

8. A damper inner pipe for the oscillation damper of claim 1, wherein the damper inner pipe comprises a plurality of support elements.

9. A damper outer pipe for the oscillation damper of claim 1, wherein the damper outer pipe comprises a plurality of support elements.

10. A method for producing a double pipe of an oscillation damper, comprising the steps of:
a) providing a damper inner pipe having a damper inner pipe wall thickness and a damper inner pipe outer wall,
b) providing a damper outer pipe having a damper outer pipe wall thickness and a damper outer pipe inner wall, and
c) fitting the damper inner pipe in the damper outer pipe with a spacing being produced therebetween,
wherein the damper inner pipe provided in step a) and/or the damper outer pipe provided in step b) comprises a plurality of support elements and the spacing between the damper outer pipe inner wall and the damper inner pipe outer wall is carried out by means of the plurality of support elements.
